(19) United States
(12) Patent Application Publication
(10) Pub. No.: US 2006/0042548 A1
(43) Pub. Date: Mar. 2, 2006

(54) Bedside pet sleeper

(76) Inventors: Douglas Tharalson, Agoura, CA (US); Diana Tharalson, Agoura, CA (US)

Correspondence Address: CISLO & THOMAS, LLP, 233 WILSHIRE BLVD, SUITE 900, SANTA MONICA, CA, 90401-1211, US

(21) Appl. No.: 11/215,371

(22) Filed: Aug. 29, 2005

Related U.S. Application Data
(60) Provisional application No. 60/605,036, filed on Aug. 27, 2004.

(51) Int. Cl. A01K 29/00

(52) U.S. Cl. 119/28.5

(57) ABSTRACT

A bedside pet sleeper comprises first, second and third side members, each with at least one pet animal ventilation opening. A fourth side member is coupled between the first and third side members and is provided with at least one pet animal doorway. Also included is a bottom member coupled to the first, second, third and fourth side members and adapted to support the weight of at least one pet animal. A top shelf portion is coupled to the first, second, third and fourth side members. The bedside pet sleeper is secured to a pet owner's bedside via one of the first, second or third side members.

### CROSS-REFERENCE TO RELATED APPLICATIONS

This application claims the benefit of U.S. Provisional Patent Application No. 60/605,036, filed on Aug. 27, 2004, which is incorporated herein in its entirety by reference.

### BACKGROUND

Pet animal owners desiring companionship with their pet animal(s) during the night are faced with pet hair problems, pests, pet odors and the like as a result of pet animals sleeping in their beds. To eliminate these problems and to provide a comfortable area for a small pet animal to sleep in during the night, it would be advantageous to have a bedside pet sleeper that allows the pet owner to have access to and companionship with the pet during the night without actually having the pet in the owner's bed. Such a pet sleeper would alleviate pet hair problems, pests associated with fur bearing animals and dirt, odors or pet dander that might be unintentionally brought to the owner's bed by the pet. A pet sleeper of this type may be used inside and outside on a patio, balcony, or the like. It may also be used as a table or storage shelf, as needed.

### SUMMARY

Exemplary embodiments disclosed herein are generally directed to a bedside pet sleeper.

In accordance with one aspect of the invention, the bedside pet sleeper comprises a first side member with at least one pet animal ventilation opening, and a second side member coupled to the first side member. The second side member has at least one pet animal ventilation opening as well. The bedside pet sleeper also comprises a third side member coupled to the second side member, wherein the third side member has at least one pet animal ventilation opening. The bedside pet sleeper further comprises a fourth side member coupled between the first and third side members, wherein the fourth side member is provided with at least one pet animal doorway. Also included is a bottom member coupled to the first, second, third and fourth side members. The bottom member is adapted to support the weight of at least one pet animal. Further included is a top shelf portion coupled to the first, second, third and fourth side members. The bedside pet sleeper includes means for securing at least one of the first, second and third side members to a pet owner's bedside.

This and other aspects of the invention will become apparent from a review of the accompanying drawings and the following detailed description of the invention.

### BRIEF DESCRIPTION OF THE DRAWINGS

The present invention is generally shown by way of reference to the accompanying drawings in which:

FIG. 1 is a front elevation view of a vertical side frame bent tube support system for use with the bedside pet sleeper of the present invention;

FIG. 2 is a front elevation view of a horizontal stabilizing frame system for use with the bedside pet sleeper of the present invention;

FIG. 3 is a front elevation view of assembled side frames with horizontal welded frames for use with the bedside pet sleeper of the present invention;

FIG. 4 is a front perspective view of a canvas fabric body which is sewn to the horizontal frames of FIGS. 2-3;

FIG. 5 is a front perspective view of a bedside pet sleeper in accordance with the present invention;

FIG. 6 is a rear perspective view of the bedside pet sleeper of FIG. 5 in accordance with the present invention;

FIG. 7 is a schematic representation of a locking system for horizontal welded frames to vertical side support frames to use with the bedside pet sleeper of the present invention;

FIG. 8A is a cut-away view of a rigid panel being used with the bedside pet sleeper of the present invention;

FIG. 8B is a front perspective view of an extensions leg system for use with the bedside pet sleeper of the present invention;

FIG. 8C is a perspective view of top and bottom rigid panels for use with the bedside pet sleeper of the present invention;

FIG. 9 is front perspective view of a pet sleeper carry case adapted to accommodate a disassembled bedside pet sleeper in accordance with the present invention;

FIG. 10 is a front perspective view of an anchor system for securing the bedside pet sleeper of the present invention to one side of a pet owner's bed;

FIG. 11 is a rear perspective view of the anchor system for use with the bedside pet sleeper of the present invention; and

FIG. 12 is a cut-away view of the anchor system of FIGS. 10-11 being used in accordance with the present invention.

### DETAILED DESCRIPTION

The detailed description set forth below in connection with the appended drawings is intended as a description of exemplary embodiments and is not intended to represent the only forms in which the exemplary embodiments may be constructed and/or utilized. The description sets forth the functions and the sequence of steps for constructing and operating the exemplary embodiments in connection with the illustrated embodiments. However, it is to be understood that the same or equivalent functions and sequences may be accomplished by different embodiments that are also intended to be encompassed within the spirit and scope of the present invention.

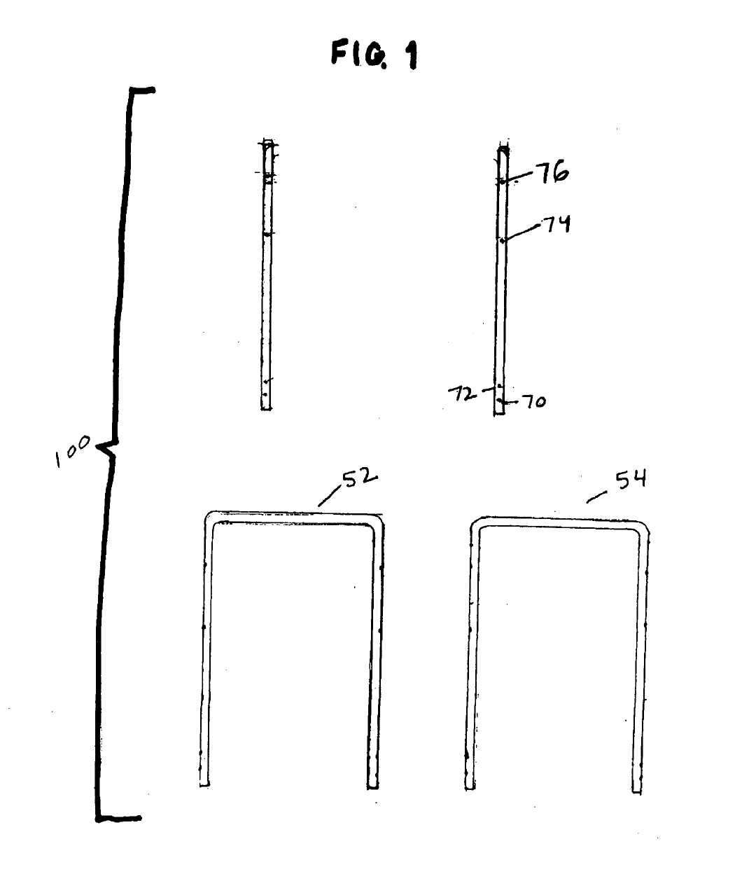

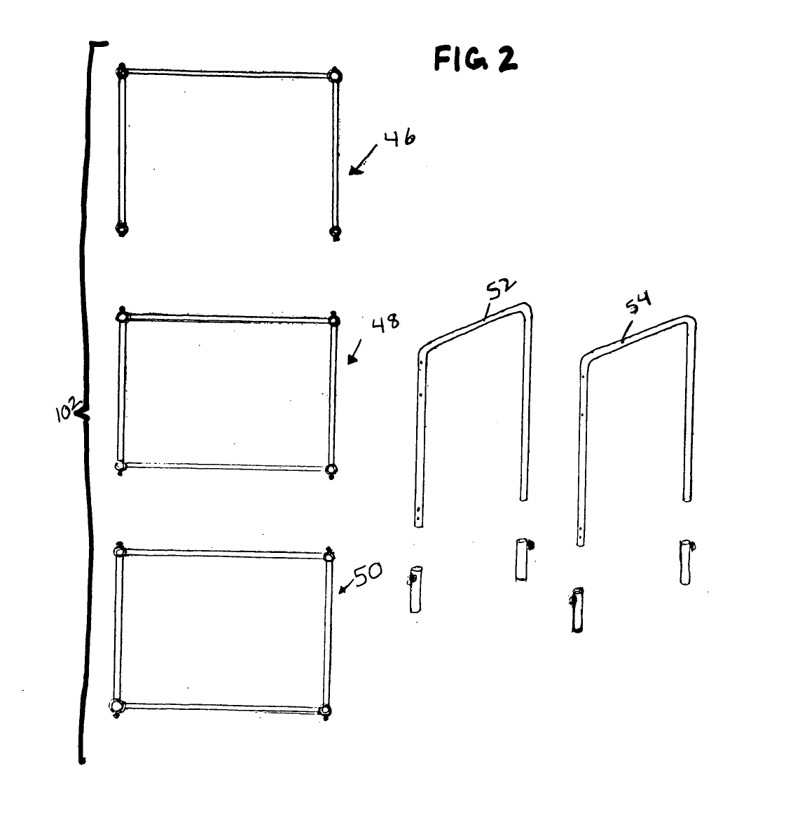

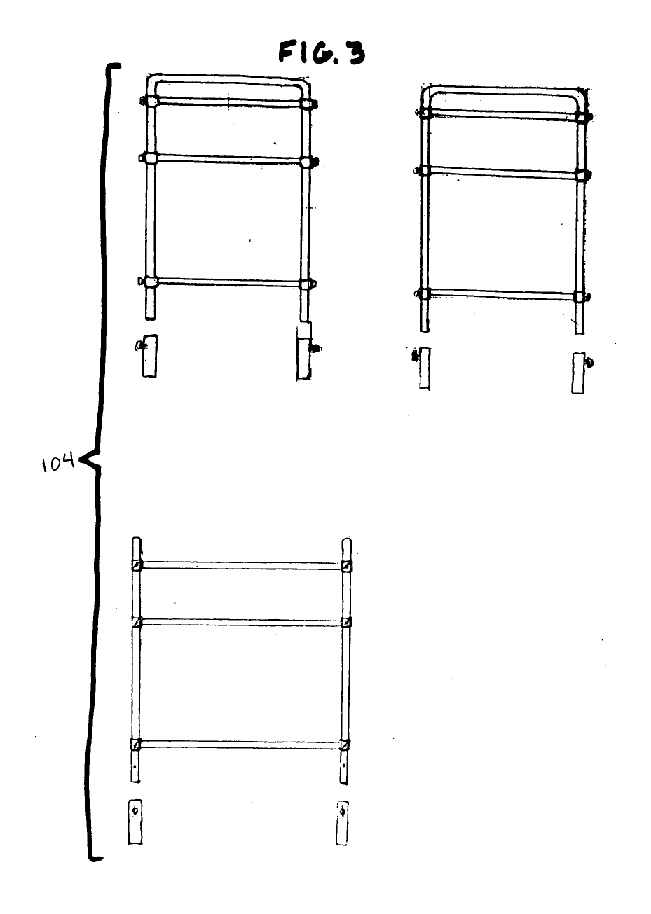

Some embodiments of the present invention will be described in detail with reference to a bedside pet sleeper, as generally shown in FIGS. 1-12. Additional embodiments, features—and/or advantages of the invention will become apparent from the ensuing description or may be learned by practicing the invention. In the figures, the drawings are not to scale with like numerals referring to like features throughout both the drawings and the description.

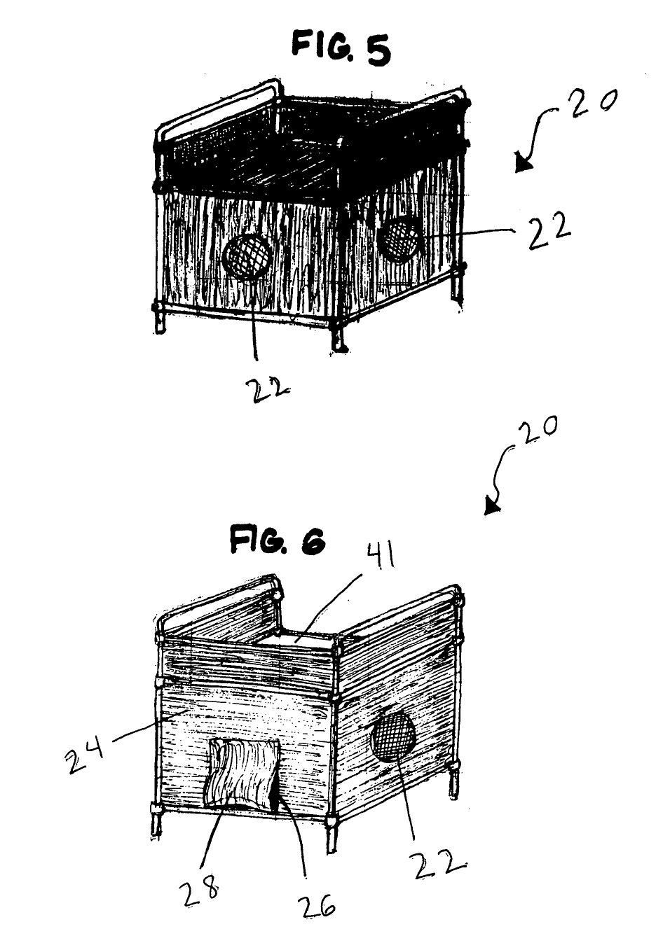

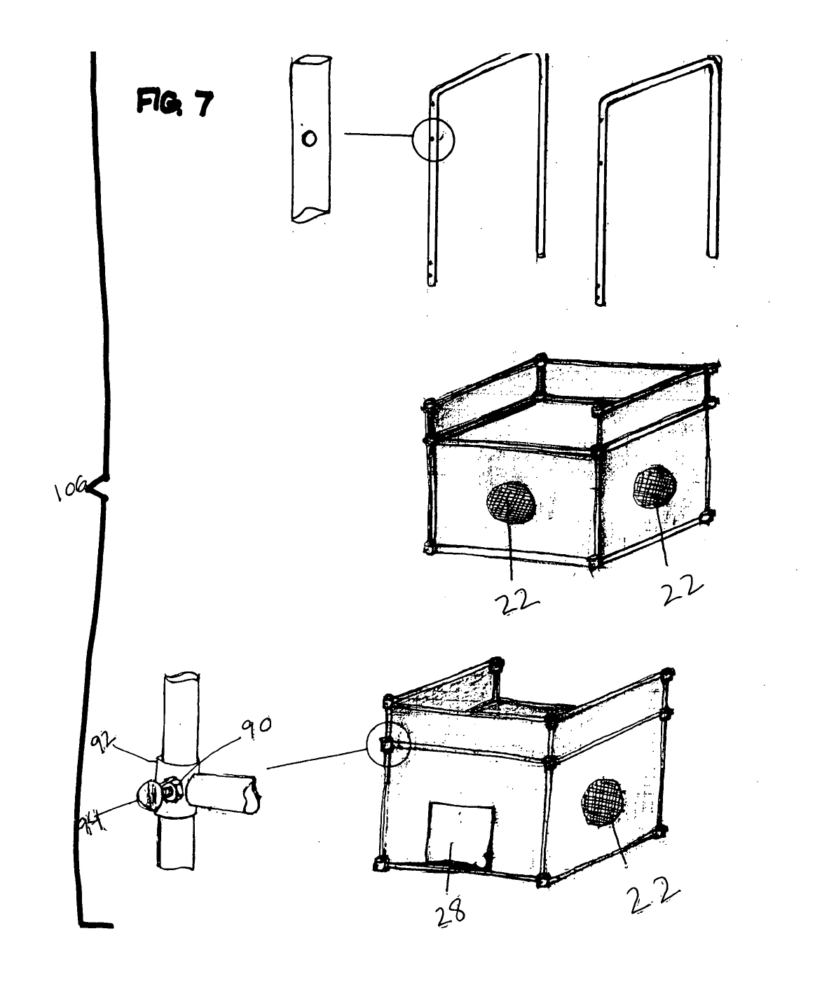

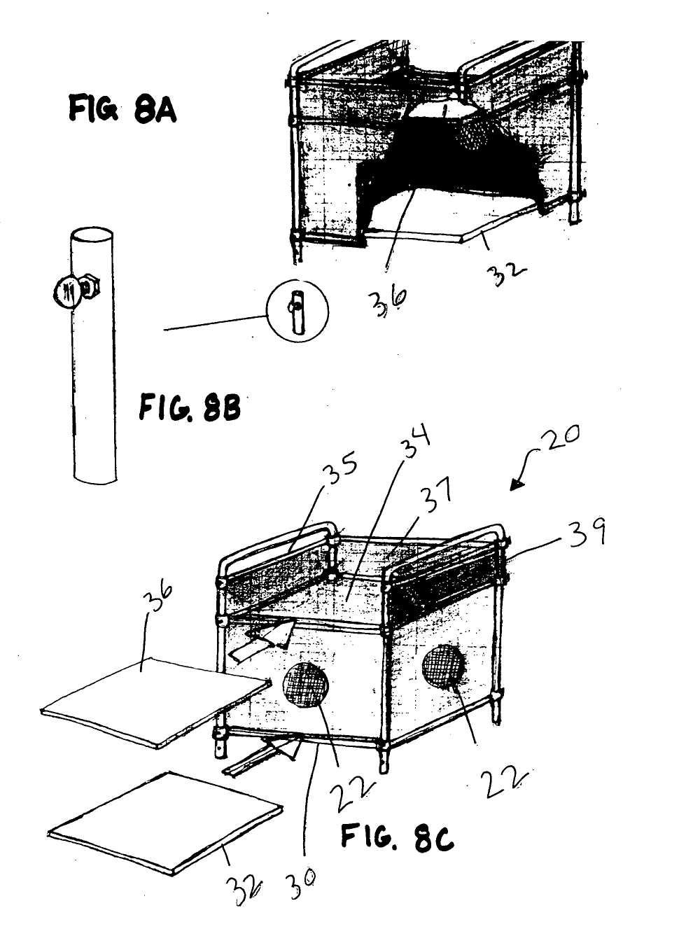

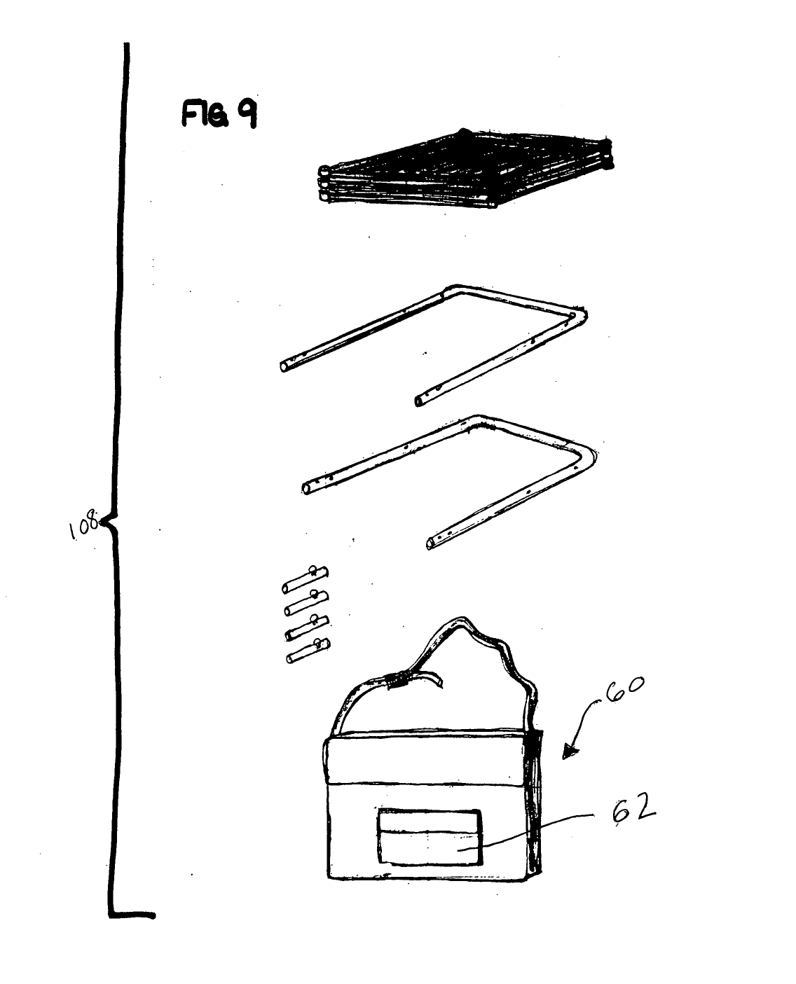

An elevated bedside pet sleeper 20 [FIGS. 5-6] includes three ventilated sides, a rear side, a top shelf and a bottom with a rigid panel sufficient to support the weight of a small pet animal. Each of the three sides has a round screened aperture 22 for ventilation that allows light in and a view out. A rear side 24 is coupled between two adjacent ventilated sides. Rear side 24 has a generally square door opening 26 fitted with a self-closing fabric flap 28 to cover door opening 26 so as to allow a small pet animal to pass freely therethrough. A bottom 30 with a rigid panel 32 [FIGS. 8A, 8C] supports the weight of a small pet animal. A ceiling which is at the same dimensions as rigid panel 32 of bottom 30 is disposed over bottom 30. Ceiling 34 is coupled between three side frames 35, 37, 39 (FIG. 8C) to form a top shelf 41 (FIG. 6). The enclosure provided by the three ventilated sides, rear side 24, bottom 30 and ceiling 34 serves as a pet house that the pet may use at will as a private, safe and personalized environment.

Pet sleeper 20 allows the pet owner to provide a comfortable area for a small pet animal to sleep in as well as to have access to and companionship with the pet during the night without actually having the pet in the owner's bed.

The advantages of this arrangement would be the elimination of pet hair, pests associated with fur bearing animals and dirt, odors or pet dander that might be unintentionally brought to the owner's bed by the pet.

Bedside pet sleeper 20 may be secured against a pet owner's bed 38 (FIG. 12) via under a mattress 40 via a strap and plate anchor system 42. The pet animal has an open-air bed near its owner and secluded private quarters for sleeping or getting away from the outside world as needed. Pet sleeper 20 may be used inside or outside on a patio, balcony or veranda, as desired. When top shelf 41 faces a wall, it becomes a table or storage shelf the enclosure below serving as an outside pet house.

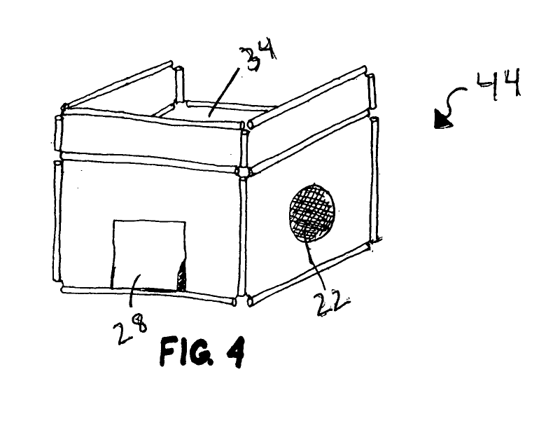

Constructing pet sleeper 20 involves sewing a canvas body 44 (FIG. 4) directly onto three tube steel square frames 46, 48, 50 (FIG. 4). Each tube steel frame has at each corner a connecting ring with a hand tightening locking bolt. The three frames are fitted onto two side support frames 52, 54 (FIG. 1). Each frame has a designated position along the length of the side support frames indicated by respective drilled holes at three different levels. As each frame finds its position, it is locked into place with hand tightening threaded bolts. Once the three frames are locked in place, pet sleeper 20 is ready for positioning next to a pet owner's bed or free standing in any room or outside.

Pet sleeper 20 may be secured to a pet owner's bed via two anchor plates 56 and two securing straps 58, as generally shown in FIG. 12. To connect pet sleeper 20 to bed 38, the user passes the two anchoring straps 58 between box spring 60 and mattress 40 of bed 38. They must be aligned along both sides of the pet sleeper and passed through whatever slot in the two sewn pockets on the front of the pet sleeper that comes closest to the top of the box spring mattress of the human bed. These straps are threaded through the above mentioned slot, up and out the top of the sewn pockets and passed through the slot found at the top of the sewn pocket.

Specifically, the user passes the strap through this slot and then reaches through pet door opening 26 (FIG. 6) located at the rear of the pet sleeper and passes the straps out through the slot on the opposite side or back of the pet sleeper's rear wall. When the mattress 40 is in place, straps 58 are pulled through the unit and anchor plates 56 serve as the means of resistance one would pull against. Directly below this rear strap slot is a vertical Velcro® strip to which the strap will be attached once the desired amount of tension has been achieved to hold the pet sleeper securely to pet owner's bed 38.

By separating canvas body 44 from the side frames, canvas body 44 and its three frames simply fold down onto each other to create a compact item. The side frames stack up on each other to create another compact item. All of these parts fit into a canvas carry bag 60 with an adjustable shoulder strap as generally shown in FIG. 9. Carry bag 60 also has a pocket 62 (FIG. 9) on the outside to hold the four extension leg tubes and pet owner bed anchoring straps.

In accordance with one exemplary embodiment of the present invention, pet sleeper 20 may be constructed using ¾″ outside diameter, light gauge round tubing (larger size tubing may be introduced for larger sizes and heavier animals). The user may bend the tube at equal lengths to create a singer shape with two 36″ legs and a top bar to separate the two legs 24″ apart. ¼″ holes 70, 72, 74, 76 may be drilled into the outside facing side of each of the four vertical legs as shown in FIG. 1.

Extension legs with locking bolts may be made of a tube size that allows them to fit over the side frame tube and lock into the first ¼″ hole up from the floor. This will give the bedside pet sleeper the adjustment to position its ceiling at 24″ and 32″ off the floor.

Canvas fabric body 44 is shown in FIG. 4 without the horizontal tube frames sewn into the fabric. This view is to illustrate the sewing phase of the pet sleeper separated from the metal parts.

The three horizontal frames are sewn into the canvas body so as to facilitate simplicity of assembly and to eliminate customer error in trying to assemble structurally critical components. The horizontal frames are welded together. There is no need to use nuts, bolts, snaps or spring lock connections which may fail due to reasonable misuse or assembly by the customer.

The horizontal frames may be made of ¾″ outer diameter tube steel welded into a rectangular shape with a slide ring at each corner. A ¼″ hex nut 90 is welded to the side of each slide ring 92 to receive a ¼″ threaded hand tightening bolt 94 that is long enough to be screwed into hex nut 90 and into the hole provided for it on the vertical leg of the side frame as generally illustrated in FIG. 7. Thus, the three horizontal frames attached to the side frames in this manner create a structural frame of welded steel and bolted connections.

The sections used for bottom 30 and ceiling 34 may be made of plastic, plywood, masonite or any other suitable material that will serve to support the weight of the pet. Each panel is to be sewn into the floor sections between two layers of canvas. These panels are positioned to sit between the tube frames.

The basic concept of the anchoring system is to be able to have something to pull against in order to secure the pet sleeper to a pet owner's bed. In this case, one may use a 6″×6″−¼″ plastic plate with a 2″ nylon strap attached to make it long enough to pass from one side of the pet owner's bed, through the length of the pet sleeper and out the back side with enough strap to attach to the back wall of the pet sleeper and hold it against the pet owner's bed.

The anchor plate and the strap lay between the box spring mattress and the top mattress of the pet owner's bed. It is important that the strap come into contact with the pet sleeper at the same elevation as where the strap comes out from between the mattress and box spring.

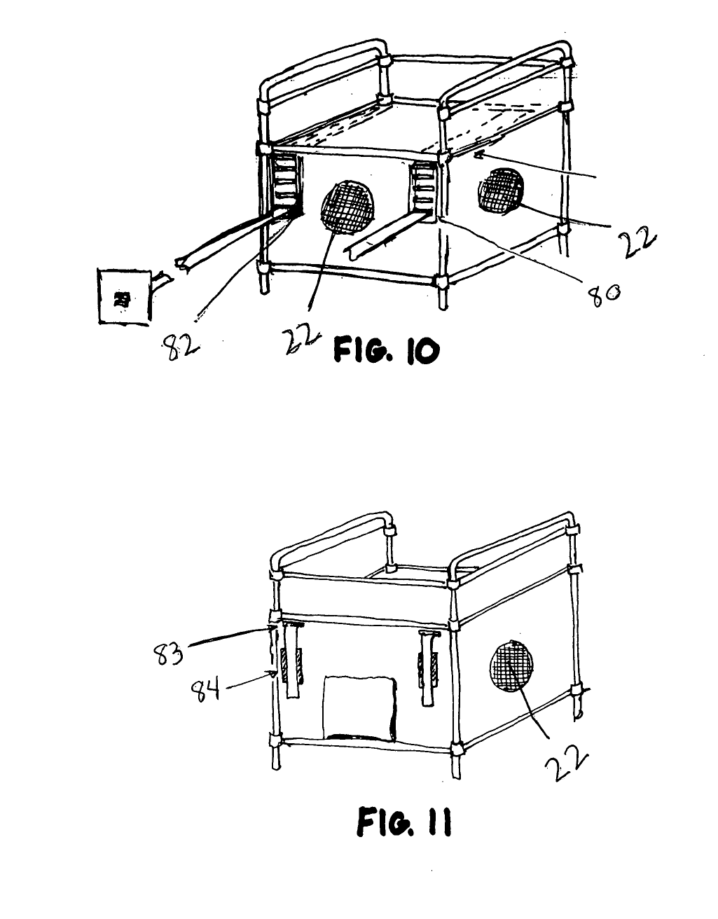

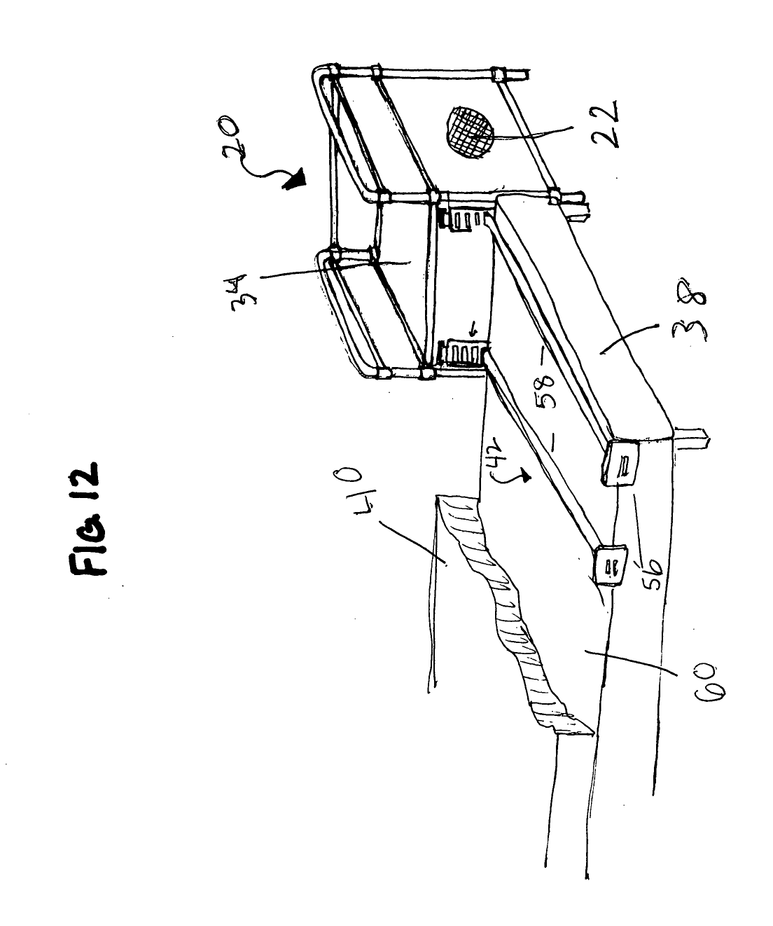

As generally depicted in FIGS. 10-12, there are two sewn “pockets” 80, 82 (FIG. 10) attached to the front of the pet sleeper at each side just under the opening for the upper sleeping nest. The user selects which slot to use determined by the height of the box spring mattress. By threading the strap into the desired slot in the pocket and drawing the strap up and out of the pocket the user then threads the strap through the slot in the pet sleeper wall just above the pocket and passes it under the sleeping nest's floor board. Reaching into the pet house area through the pet door the user now takes the end of the strap and passes it through the slot on the back wall of the pet sleeper just under the floor panel. By pushing the pet sleeper against the human bed with one hand and pulling the strap tight with the other hand, the pet sleeper is ready to be secured into that position. An exit slot 83 for strap 58 is shown at the rear of pet sleeper 20 in FIG. 11.

The final move is to press the remaining strap onto a Velcro® strip 84 (FIG. 11) attached to the back wall of the pet sleeper. The user repeats this move with the remaining strap and plate until pet sleeper 20 is held securely to the bed 38 (FIG. 12). Once mattress 40 is in place and the strap and plate between the mattress and box spring of the human bed are secured, pet sleeper 20 is securely attached to bed 38.

Reference numerals 100, 102, 104, 106 and 108 refer to associated component systems, as generally described herein above.

The bedside pet sleeper of the present invention may be assembled in other ways and/or with other suitable components and/or materials, as long as there is no departure from the intended purpose and scope of the present invention. The exemplary embodiments described hereinabove are merely illustrative of the general principles of the present invention. Various design modifications may be employed that would reside within the scope of the invention. Thus, by way of example, but not of limitation, alternative configurations may be utilized in accordance with the teachings herein. Accordingly, the drawings and description are illustrative and not meant to be a limitation thereof.

Moreover, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Thus, it is intended that the invention cover all embodiments and variations thereof as long as such embodiments and variations come within the scope of the appended claims and their equivalents.

What is claimed is:

1. A bedside pet sleeper, comprising:
a first side member with at least one pet animal ventilation opening,
a second side member coupled to said first side member, said second side member having at least one pet animal ventilation opening;
a third side member coupled to said second side member, said third side member having at least one pet animal ventilation opening;
a fourth side member coupled between said first and third side members, said fourth side member being provided with at least one pet animal doorway;
a bottom member coupled to said first, second, third and fourth side members, said bottom member adapted to support the weight of at least one pet animal;
a top shelf portion coupled to said first, second, third and fourth side members; and
means for securing at least one of said first, second and third side members to a pet owner's bedside.

2. The bedside pet sleeper of claim 1, wherein said bottom member includes at least one ridged panel configured to support the weight of at least one pet animal.

3. The bedside pet sleeper of claim 1, wherein said top shelf portion includes at least one ridged panel.

4. The bedside pet sleeper of claim 1, wherein each of said first, second, third and fourth side members includes vertical and horizontal side frame bent tube support sections.

5. The bedside pet sleeper of claim 1, wherein said securing means includes at least one anchor plate and associated bed strap.
